(19) United States
(12) Patent Application Publication
(10) Pub. No.: US 2010/0019026 A1
(43) Pub. Date: Jan. 28, 2010

(54) PRODUCT AUTHENTICATION SYSTEM

(76) Inventors: Barry Hochfield, East Kilbride (GB); Stephen McSpadden, East Kilbride (GB); Paul Connor, Livingston (GB); Raglan Tribe, Hampshire (GB); Ken MacLauchlan, Hampshire (GB); Stephen Todd, Hampshire (GB)

Correspondence Address: MOORE & VAN ALLEN PLLC, P.O. BOX 13706, Research Triangle Park, NC, 27709, US

(21) Appl. No.: 12/296,278

(22) PCT Filed: Apr. 5, 2007
(86) PCT No.: PCT/GB2007/001248

§ 371 Date: Aug. 25, 2009

(30) Foreign Application Priority Data
Apr. 7, 2006 (GB) 0607052.8
Jan. 19, 2007 (GB) 0701042.4

(51) Int. Cl. G06F 17/00

(52) U.S. Cl. 235/375

(57) ABSTRACT

A system for authenticating articles comprising: an authentication manager for managing authentication information associated with the articles; a plurality of secure taggant reader instruments for reading machine readable taggants associated with the articles, the taggants including the authentication or related information, and an instrument configuration manager for secure on-line configuration of the instruments. Each taggant reader instrument is operable to securely process and send authentication information derived from a taggant to the authentication manager. The authentication manager uses the received authentication information to identify suspicious events. When suspicious events are detected, the instrument configuration manager is able to reconfigure at least some of the taggant reader instruments. Reconfiguration may also happen in the event of a product recall and/or taggant security compromise.

The present invention relates to product tracking and authentication systems for use in, for example, the pharmaceutical products or aircraft parts industries. In particular, though not exclusively, the invention concerns a secure authentication system for use with machine readable taggants.

### BACKGROUND OF THE INVENTION

Machine readable taggants are commonly used by brand owners in product tracking systems. Such taggants include barcodes, radio frequency identification (RFID) tags and the like. The products to be tracked, for example pharmaceutical drugs or aircraft parts, each have a tag fitted to them, the tag containing unique identification information for that product which can be retrieved by scanning or otherwise reading the tag at a later time. The scanned information can be checked against stored records/data in order to assess the authenticity of the product being checked.

Machine readable taggant product tracking systems are typically built around a particular taggant technology, such as radio frequency identification (RFID) or others. The effectiveness of the solution in terms of counterfeiting solely relies on the properties and secure handling of the taggant material. If the integrity and/or security of the particular taggant were compromised in any way the only option available to the brand owner is to install a completely different taggant technology into their product tracking system. This is extremely expensive and time consuming for the brand owner. Similarly, the personnel responsible for performing the checks on the products may be involved in fraudulent activities and so attempt to compromise the integrity checking process through improper handling of the checking equipment or the products or by altering the results and/or records of the integrity checking events.

### SUMMARY OF THE INVENTION

According to one aspect of the present invention, there is provided a system for authenticating articles using information received from a plurality of taggant reader instruments, the taggant reader instruments being operable to read machine readable taggants associated with the articles, the taggants including the authentication or related information, the system comprising: an authentication manager for managing authentication information associated with the articles, and an instrument configuration manager for secure on-line configuration of the instruments, wherein the authentication manager is operable to use the authentication information received from the taggant reader instruments to identify suspicious events and the instrument configuration manager is operable to reconfigure on-line at least some of the taggant reader instruments when such suspicious events are identified and/or in response to a product recall and/or taggant security compromise.

By allowing secure on-line reconfiguration of the taggant reader instruments, the system is able to respond quickly and effectively to any perceived threat to security. Reconfiguration may include updating or revocation of cryptographic keys that are used at the taggant readers as part of the authentication process and or policies defined by the brand owner. The policies may define the type of taggant to scan; the order in which features are to be scanned; the type of processing to use to determine authentication information; where more than two taggants are on the article, which combination of taggants is to be used; the status and/or identity of the person authorised to use the reader.

The instrument configuration manager may be operable to configure one or more of the following reader functions: type of taggant to scan; the order in which features are to be scanned; the type of processing to use to determine authentication information; where more than two taggants are on the article, which combination of taggants is to be used; the status and/or identity of the person authorised to use the reader; one or more cryptographic keys for use in the taggant reader instruments in accordance with a key management scheme. Preferably, a record of a taggant reader's configuration is stored as a function of time, so that a complete record of the reader's status and functionality is retained.

At least one of the taggant readers may be operable to determine the authenticity of an article using information read from the machine readable taggant, so that the taggant authenticity can be determined off-line. Alternatively or additionally, authentication may be done on-line by sending authentication information to the authentication manager, thereby to allow it to determine authenticity of the article.

According to another aspect of the invention there is provided a system for authenticating articles, the system comprising database means for storing authentication information, taggant reader means for reading machine readable taggants physically associated with said articles, and taggant reader management means configured to enable communication, preferably in a secure manner, between said database means and said taggant reader means, wherein said management means is configured to extract generic authentication information from taggant technology specific data read from said machine readable taggants by said taggant reader means, and compare said extracted generic authentication information with authentication information stored in said database means, whereby the system may be used with a multiplicity of different taggant reader means utilising different taggant technologies for reading respective different types of taggants.

According to a further aspect of the invention there is provided a system for authenticating articles, the system comprising database means for storing authentication information, taggant reader means for reading machine readable taggants physically 20 associated with said articles, and taggant reader management means configured to enable communication, preferably in a secure manner, between said database means and said taggant reader means, wherein said management means is configured to perform dynamic reconfiguration of said taggant reader means.

The database means is preferably remote from the taggant reader means. The communication therebetween may be performed via the Internet, or an Ethernet or other local wired or wireless network, whichever is most appropriate according to the physical/geographical locations of the database means and the taggant reader means.

The taggant reader means may comprise scanning means for scanning a machine readable taggant such as, for example, a barcode. Alternatively, or additionally, the taggant reader means may include other sensor means for reading taggants such as, for example, RFID tags.

The taggant reader means may further include taggant write means for generating taggants to be applied to articles to be authenticated. For example, the write means may comprise one or more label printing devices for printing, for example, bar codes onto paper labels, which can be applied to the articles. The taggant reader management means may be configured to perform dynamic reconfiguration of the write means of the taggant reader means.

Optionally, the taggant reader means may comprise an instrument provided with a plurality of scanning “heads”, each head being formed and arranged for scanning a different type of taggant. One or more of said scanning heads may be configured to be replaceable. For example the scanning heads may be designed to be “plugged” in and out of the instrument as and when they are required.

The taggant reader management means may comprise a common taggant interface (CTI), which may be provided in the instrument in which the taggant reader means is provided. The CTI is preferably configured to interface with a taggant technology specific subsystem associated With each said scanning head. Alternatively, the CTI may be provided partly, or entirely, as a software interface implemented within the taggant reader means.

According to a third aspect of the invention there is provided a system for authenticating articles, the system comprising database means for storing authentication information, taggant reader means for reading machine readable taggants physically associated with said articles, and taggant reader management means configured to enable communication between said taggant reader means and said database means, wherein said management means comprises at least one secure application module (SAM) for controlling the communication of sensitive information between said taggant reader means and said database means.

The taggant reader means may comprise a plurality of taggant reader instruments which may be located at different physical locations. Preferably, at least one SAM is provided in each taggant reader instrument.

The taggant reader management means preferably further includes a trust management system (TMS) via which all communications between the taggant reader means and the database means are made. The TMS is configured to ensure that all such communications are made in a secure manner. For example, the TMS may be configured to encrypt communications between said taggant reader means and said database means. The TMS preferably includes a Hardware Security Module (HSM) for communicating with the SAMs in the taggant reader instruments. The TMS may conveniently be provided in a first server and the database means may be provided, at least partially, in a second server. The system may include web server means via which the taggant reader means may communicate securely with the TMS Application Server.

Preferably, the system further comprises user input means for obtaining user identification information physically associated with a user of the system. For example, the user identification information may be provided on or in one or more of the following: a SMART card/chip or a similar secure token; biometric features of the user, e.g. the user's fingerprint; a barcode; an RFID tag; a user password and/or login details. The user input means therefore may, for example, comprise a SMART card/chip or token reader means, biometric scanning equipment, or a barcode or RFID reading means, or a user input keypad.

The user input means may comprise a plurality of user input means optionally located at different physical locations. Conveniently, the or each said user input means may be provided in the same instrument as the or each said taggant reader means.

The user input means may comprise machine readable taggants (e.g. barcodes) of the same type as those associated with the articles to be authenticated, each user being provided with a said machine readable taggant containing their user identification information. The barcode may be provided, for example, on a badge which the user wears. The taggant reader means may therefore be used for reading these user taggants. Conveniently, the write means may be configured for generation of such personnel machine readable taggants, e.g. barcode labels.

The system may include user authentication management means configured to enable communication, preferably in a secure manner, between said database means and said user input means, and to compare user identification information obtained by the user input means with user authentication data stored in the database means, whereby a user can be authenticated. Conveniently, the user authentication management means may be provided as a function of said taggant reader management means. The user input means and/or taggant reader means may conveniently include data storage means for storage of authentication events data records. The system may further include display means for indicating status, instructions and/or other information to a user.

The user authentication management means or the taggant reader management means may be configured to store the authentication information obtained by the user input means as an event record, in a memory means provided therefor in the taggant reader means. Where the taggant reader means is offline from the database means while obtaining this authentication information, the stored information may then be uploaded from the memory, for example to a central server of the system, the next time the reader means is online.

Optionally, the user authentication management means or the taggant reader management means may be configured to incorporate at least a portion of the user authentication information obtained by the user input means into a taggant to be applied to an article to be authenticated. In this manner it will be appreciated that personnel involved in authenticating articles can effectively digitally sign event records corresponding to taggant reading operations carried out by said personnel. The TMS may be configured to generate a respective encryption key for each authorised user which key is used to encrypt event records and/or digital signatures created by that user.

The user authentication means may further be configured to provide a privilege management system. For example, in such a system an authenticated user may only be allowed access to the authentication system for a limited period of time, for example a few hours, after which the user must then be re-authenticated by repeating the user authentication process described above. Alternatively, or additionally, the privilege management system may be configured to allow different user personnel different levels of access to the authentication system e.g. high level, detailed access and low-level, limited access.

The database means is preferably configured to store configuration data, for example predetermined instrument configurations, for controlling the operational configuration of the taggant reader means. The database means may be further configured to store identification data relating to said articles and/or authentication data relating to authorised users of the system. Advantageously, the taggant reader management means may be configured to dynamically download stored configuration data from the database means to a data storage means provided in the taggant reader means, preferably via said trust management system (TMS) whereby the configuration data is downloaded in a secure manner to the taggant reader means.

The configuration data may be encrypted (by the TMS) prior to download to the reader means. A key for decrypting the encrypted configuration data may be downloaded to the reader means together with the encrypted configuration data. The taggant reader management means may be configured to download different configuration data to different ones of a plurality of taggant reader means, depending on requirements detected by the system in the field during use of the system. The database may also be configured to store configuration data relating to the user input means, where these are different to the taggant reader means, and the user authentication management means may be configured to perform dynamic reconfiguration of said user input means, preferably in a similar manner to the dynamic reconfiguration performed by the taggant reader management means.

The trust management system (TMS) preferably comprises a plurality of functional modules comprising: a brand registration and administration module configured to allow operational data to be entered and amended in said database means; a brand owner key management sub-system configured to allow brand owner article identification information and/or verification key information to be entered and amended in the database means; a brand owner key management sub-system configured to enable brand owners to authorise and authenticate personnel who handle articles to be authenticated, and to verify event records generated and/or signed by said personnel; a system administration module configured to provide information on the status of the database means and/or content of the database means; and an authentication sub-system module configured to provide authentication functions and security functions.

The authentication sub-system module may comprise a plurality of sub-modules for carrying out different functions. These sub-modules may include one or more of the following: a physically tamper resistant hardware security module (HSM) sub-system configured to provide secure key generation and key storage and the processing of similarly sensitive data, in a like manner to the role performed by the SAM in each taggant reader instrument; a secure log-in and authentication sub-module configured to ensure users of the system are authenticated, and to provide security between two or more of the system modules; an audit sub-system configured to generate reports and/or generate alarm signals, and a message sub-system configured for sending and receiving messages between one or more of the system modules. An alarm signal may be generated when an unauthenticated user is detected by the secure log-in and authentication sub-module.

According to yet another aspect of the invention, there is provided a system for authenticating articles that bear one or more machine readable taggants, the system comprising management means for managing authentication information relating to the articles, the authentication information being received from a plurality of different taggant readers operable to read different taggants or types of taggants, each reader being arranged to read taggant specific information from taggants, the system including a common interface for converting data from the multiple reader devices into a generic or common format.

A significant benefit of the invention is that the system is capable of making use of several different taggant technologies, where the management means is configured to allow the taggant reader means to be used to read a plurality of different types of taggant, or to allow use of a plurality of different taggant reader means. Additionally or alternatively, the system can be automatically reconfigured to, for example, read different taggants or different taggant features on any one article, where the taggant reader interface means is configured to allow automatic reconfiguration of the taggant reader means. Thus, different taggant technologies can be introduced, made obsolete, supported simultaneously or even combined with a new system. This offers brand owners and other stakeholders in the system a more flexible and future-proofed approach. For example, they have the ability to manage their product authentication/management operations by introducing new and different counter measures against counterfeiters far more quickly and easily than before.

The system preferably includes a central server for communicating with, and allowing communication between, the plurality of system modules and the database means. This central server may be the TMS Application Server, as described previously.

The database means is preferably a distributed database in which, preferably, the database means comprises a plurality of database modules located in different physical locations, for example at different factory/warehouse sites in a product supply and distribution chain. Optionally, one or more of said taggant reader instruments may incorporate at least one said database module. A significant advantage of this is that, should on-line connection to the central server fail at any time, in use of the system, said one or more taggant reader instruments may still have some “offline” capability which allows certain operations of the taggant reader means to be performed, by virtue of the fact that the local database module contained therein may, for example, be programmed with some authentication information relating to articles to be authenticated and/or personnel to be authenticated and/or configuration information for configuring the taggant reader means.

The taggant reader means may be formed and arranged to read one or more types of machine readable taggants. Such taggants may, for example, include barcodes, one dimensional or two dimensional, RFID tags, fluorescent tags, or any other suitable taggant types. In most cases the machine readable taggants will be physically attached to, or otherwise incorporated in, the articles to be authenticated/managed. However, in some cases the taggant may simply comprise an inherent feature of the article itself which the taggant reader means is configured to read, e.g. a visible or covert feature which the reader means is designed to detect/read. Therefore, for the avoidance of doubt, it will be understood that the term “taggant” as used herein is not intended to be limited to physical tags or markers attached to articles to be authenticated but is intended to also include such visible or covert features inherent in an article itself.

The system may include a plurality of taggant reader means located at different geographical sites. Each such taggant reader means is preferably provided with a communication interface for communicating with the system's central server, in particular the taggant reader management module thereof, for exchange of information therebetween. The taggant reader management means may be configured to dynamically download stored configuration data from the database means to a data storage means provided in the taggant reader means.

The system, for example, the brand registration and administration module thereof, may be arranged to define a plurality of different alert states to be detected, and one or more of said taggant reader means and/or user authentication management means may be configured to detect any one of said alarm states and to generate a respective alarm signal when a said alarm state is detected, and to communicate said alarm signal to the central server via said communication interfaces. Optionally, the taggant reader means and/or user authentication management means may be capable of functioning in an offline capability, i.e. not in communication with the central server, but may be formed and arranged so as to go on-line to the server upon generation of a said alarm signal.

The predefined alert states may, for example, represent different threat levels from counterfeiters. The benefit of this system is that the authentication procedure can be set to different sensitivity levels depending on the level of perceived threat, e.g. the reader means can be set to perform a very sensitive authentication procedure where there is a high perceived threat from counterfeiters. Different threat levels could be set for instruments in different countries, different locations or different product types. This allows product authentication resources to be concentrated where there is a high threat and less time and resources to be wasted in areas where there is a low threat.

The system is preferably configured to perform a predetermined action upon detection of a particular alarm signal. For example, the system may, by means of the reader configuration function of the taggant reader management means module, be formed and arranged to automatically reconfigure one or more of said taggant reader means, preferably substantially in real time, to read a different type of taggant and/or a different taggant feature associated with the articles being authenticated/managed. Thus, where one taggant, or taggant feature, is compromised the system can be switched to read a different taggant, or different taggant feature.

Reconfiguration may include the step of downloading a new set of “feature extraction” data to the taggant reader means for use thereby. This downloaded data is preferably encrypted prior to download and a key is downloaded together with the encrypted data, and the taggant reader means is configured to decrypt the encrypted feature extraction data using said downloaded key. Preferably, the system is arranged to allow only one key to reside in any one taggant reader instrument at any time.

According to another aspect of the invention there is provided a method of authenticating articles comprising the steps of: storing on a database means configuration information for controlling the configuration of a taggant reader means; using said taggant reader means to read a machine readable taggant physically associated with an article; providing taggant reader management means for enabling communication between said database means and said taggant reader means, wherein said management means is configured to perform dynamic reconfiguration of said taggant reader means.

Communications between the database means and the taggant reader means may be carried out via the Internet. The method may further include the step of changing automatically the operational configuration of the taggant reader means, using the taggant reader management means, when a counterfeiting threat is identified.

The method preferably includes the step of downloading predetermined instrument configuration data from said database means to the taggant reader means via secure communication means. Preferably, this is done dynamically.

According to a yet further aspect of the invention there is provided a method of authenticating articles comprising the steps of: storing authentication information relating to said articles; reading machine readable taggants physically associated with said articles; extracting generic authentication information from taggant technology specific data read from said machine readable taggants; and comparing said extracted generic authentication information with said stored authentication information, so as to determine whether said articles are authentic or not, whereby a multiplicity of different taggant reader means utilising different taggant technologies may be used for reading respective different types of taggants. Preferably, the authentication information is stored in a remote database.

According to still another aspect of the invention, there is provided an authentication system for authenticating articles that bear one or more machine readable taggants, the system comprising management means for managing the operational state or configuration of a plurality of machine readable taggant instruments, for example a taggant reader and/or taggant writer, wherein the management means is operable to send to one or more of the instruments configuration or control instructions for implementing an on-board process, for example a taggant authentication process. The articles to be authenticated may bear two or more taggants and the configuration or control instructions may be operable to cause the reader to read a particular one of the taggants.

According to a further aspect of the invention, there is provided a taggant reader for reading taggant specific information from one or more different machine readable taggants, the reader being operable to process the read information to provide authentication information, wherein the reader is reconfigurable to read one or more different taggants and/or to use different processes for processing the read information

### BRIEF DESCRIPTION OF THE DRAWINGS

Preferred embodiments of the invention will now be described, by way of example only, and with reference to the accompanying drawings in which:

FIG. 1 is a schematic block diagram of a modular trust management system (MTMS) according to one embodiment of the invention;

FIG. 2 is a diagram illustrating operational data flow in “level 1” system partitioning of the trust management system of FIG. 1;

FIG. 3 is a block diagram illustrating a brand protection management (BPM) scheme incorporating the trust management system of FIGS. 1 to 3;

FIG. 4 is a diagram of “level 2” system partitioning, indicating operational data flow, in the trust management system of FIGS. 1 and 2;

FIG. 5 is a flow diagram (in UML language) illustrating a high-level business entity model of the BPM scheme of FIG. 3;

FIG. 6 is a sequence diagram (in UML language) illustrating a User Authentication process;

FIG. 7 is a schematic block diagram of an authentication instrument for use in the brand protection management scheme of FIG. 3;

FIG. 8 is a schematic block diagram of an alternative authentication instrument for use in the brand protection management scheme of FIG. 3;

FIG. 9 is a sequence diagram for a BPF read event for both the instruments of FIGS. 7 and 8 and

FIG. 10 is a schematic block diagram of an embodiment of the system of FIGS. 1 to 4 incorporating a dynamic alert state function.

### SPECIFIC DESCRIPTION OF THE DRAWINGS

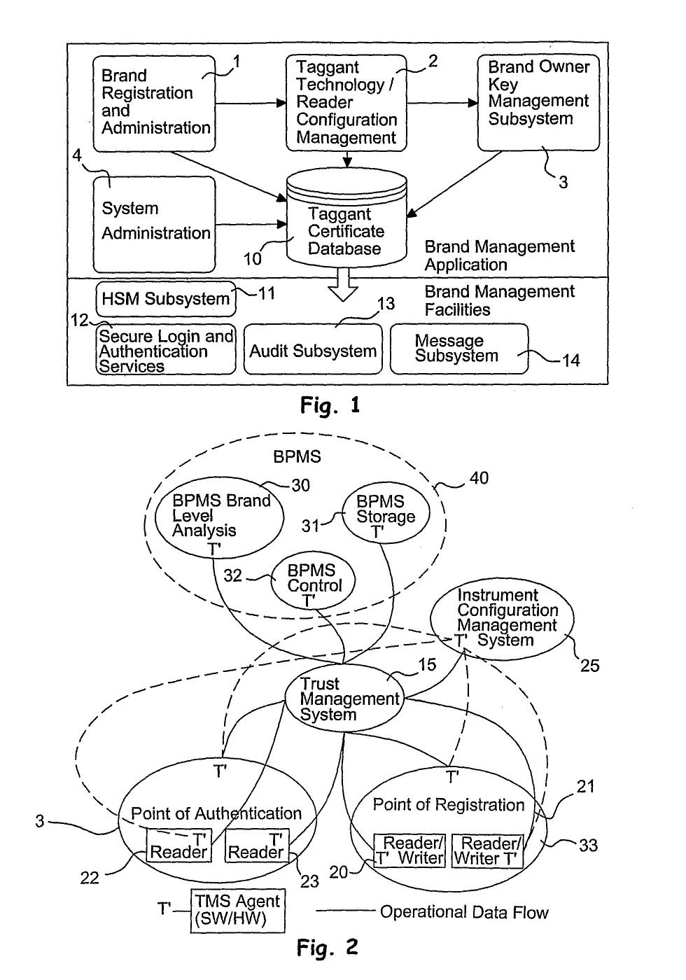

FIG. 1 illustrates various components of a Modular Trust Management System (MTMS) for use by brand owners to authenticate/monitor/manage products in a supply chain. Such a system may, for example, be used by pharmaceutical companies to trace the progress of packets or pallets of drug products. Such a system may equally be of use to aircraft manufacturers and airline operators to keep track of genuine aircraft (spare) parts. Other applications of the system are also possible, for example in tracking/managing branded consumer goods such as whisky, perfume, designer clothing etc. Counterfeiting of products/articles is a big problem in these industries and there is a significant need for a dynamic platform that can be used to rapidly address and counter threats from counterfeiters.

The MTMS of FIG. 1 has a taggant certificate database 10 for storing taggant and user identification/authentication information. It also has various functional modules, including a brand registration and administration module 1; a taggant technology/reader configuration management module 2; a brand owner key management module 3 and a system administration module 4 for providing access to various housekeeping functions, such as information on the status and/or content of the database. Each of these functional modules interfaces and is able to communicate with the taggant certificate database 10.

The brand registration and administration module 1 allows operational data to be entered and amended in the database 10; the addition of a new brand owner and/or a new brand owner product to the database and the update of a particular brand owner's details on one of their products. This module 1 interfaces with the reader configuration management module 2, which allows the addition of new technologies/readers; entry and amendment of taggant technology data and taggant instrument data that is stored in the database 10; the update of the capabilities of a particular registered instrument, and the update of key material associated with a particular reader for that device's management. The management module 2 interfaces with the brand owner key management module 3, which allows brand owner certificate generation and verification keys to be entered and amended in the database 10. This is a generic interface that allows generation, rollover, destruction, revocation and archive of keys irrespective of the specifics of the algorithm, certificate format and key length for a particular brand owner and/or product.

Each of the modules 1 to 4 and the database 10 is included in a brand management application layer. Associated with this is a brand management facilities layer. This includes various management subsystems, including a hard ware security module (HSM) subsystem 11; a secure login and authentication services subsystem 12; an audit subsystem 13 and a message subsystem 14. The first of these, the HSM subsystem 11 provides secure tamper resistant cryptographic operations and secure tamper resistant key storage, namely: key generation; key revocation; key archive; signature and generation/verification. The HSM 11 generates different keys for different required functions/situations in the MTMS system. For example, in one embodiment the keys used for carrying out secure messaging may be different from the keys used for re-configuring instruments, and different keys again may be used for other functions e.g. creating digital signatures from different user personnel.

The login and authentication subsystem 12 ensures users of the system are suitably authenticated and that communication between the secure server and the client PC is secure. It also provides challenge/response generation/verification and algorithm selection/identification. The audit subsystem 13 provides generation, verification, certification and reporting on authentication events and alarms; generates reports by product, brand owner, and instrument etc. and provides alarm registration and reaction management. The messaging subsystem 14 handles the communications for the brand management application for sending and receiving messages in a secure and reliable fashion. It also guarantees message delivery and provides asynchronous messaging, message auditing and persistent messaging, i.e. messages are delivered even if sub-system server goes down.

The trust in the integrity of any data, event or operation within a taggant scheme is based on two factors. Firstly, the access to and usage of all materials and devices constituting a particular taggant are controlled so that there is high confidence that only authorised application of the taggant occurs. This in turn implies secure handling procedures that must be auditable and accountable. Secondly the secure handling of all sensitive information is required to establish trust in any security management scheme. This applies to all electronic operations, transactions and events, such as: authentication of data, integrity verification of an entity or event, and generation of a non-reputable record or certificate. This in turn implies that the handling of cryptographic key material used to enforce said electronic operations is conducted in a manner equivalent to the handling of the taggant material and devices, so as to ensure and maintain trust and confidence in the overall scheme.

The MTMS of FIG. 1 does not rely on any one type of taggant. Instead, it can accommodate the operation and management of several, indeed many, different types of taggants singly or simultaneously. For example, the MTMS can accommodate RFID readers, ID bar code reader, 2D bar code readers, etc. The MTMS handles the dynamic management of each of the many possible taggants that could be used. For example, the MTMS can handle taggant life cycle events such as the phase out of one type of taggant (obsolescence) and the introduction of a new type to replace it. Also, the MTMS is capable of handling more sophisticated classes of taggant, whereby their effectiveness relies not solely on the device or material of the taggant but on combinations of functionalities such as cryptographically protected data coupled to and/or stored within the taggant. This affords new levels of resistance to counterfeiting and secure tracking and tracing of products flows through distribution, so as to 10 g the entire history of the product's life. These advantages will be further appreciated from the following more detailed description of the system.

The MTMS of FIG. 1 is implemented in practice in the form of a central Trust Management System (TMS) 15, embodied in a server machine or machines, and a plurality of Trust Management System agents (TMSA) T′ that act as representatives of the TMS system within those entities that require services remotely from the TMS system. The MTMS of FIG. 1 is used as part of or in conjunction with a general Brand Protection Management (BPM) scheme for use by Brand owners. The BPM scheme in this embodiment is based on a machine-readable security tagging (MST) system. Basic MST systems, such as barcode scanning systems, are common in the art and will be well understood by the skilled person. In the present invention, a modified/improved MST system, incorporating the afore-described MTMS, is proposed.

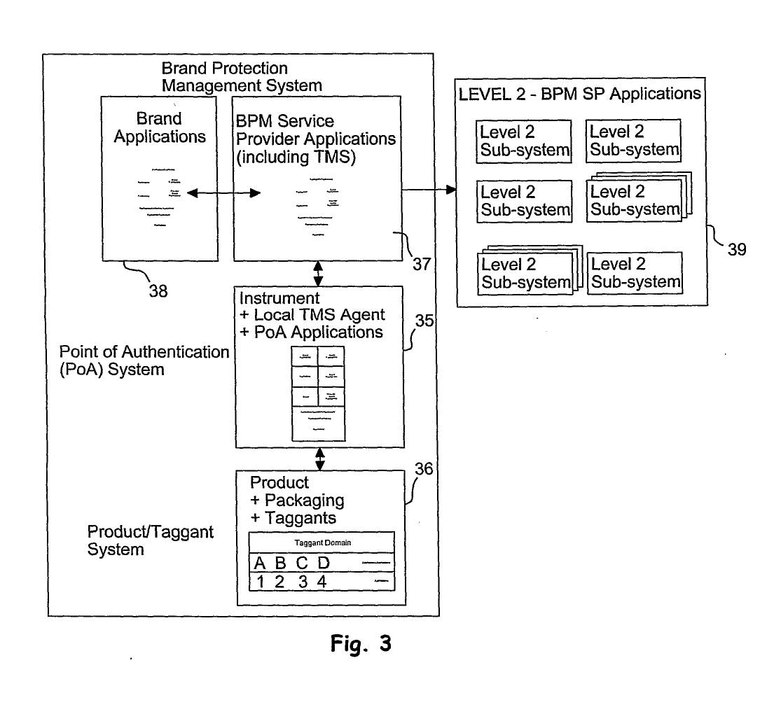

FIG. 2 illustrates operational data flow (see solid lines) at “level 1” system partitioning in a BPM scheme. The broken lines in FIG. 2 represent management message flow. In this scheme, point of registration (PoR) taggant reader/writer devices 20, 21 and point of authentication (PoA) reader devices 22,23 are provided at various locations in a product distribution chain. The reader devices 22,23 include taggant reader devices for reading taggants on articles being authenticated, and may also include user authentication devices such as, for example, SMART card readers, for reading user identification information provided by a user for authentication purposes. In some cases the reader devices 22,23 may also have a write capability so that they can generate taggants, e.g. labels, as well as read them. The PoR devices 20,21 are taggant reader/writer devices capable of generating taggants to be applied to new, that is not previously authenticated, articles, at a start or “registration” point in the BPMS scheme. The PoR and PoA devices 20,21,22,23 communicate with a main server system comprising various Service Provider Applications, one of which is the central Trust Management System (TMS) 15, using whatever standard communication method is most appropriate for them, e.g. TCP/IP over LAN for fixed devices, or WiFi for portable devices or GSM etc. Importantly, though, the devices all use TCP/IP over the Internet for connectivity.

Other service provider applications include the following: brand protection management system brand level analysis 30; brand protection management system storage 31; and brand protection management system control 32. These three applications 30,31,32 will be referred to collectively as the brand protection management system (BPMS) 40. Each of these applications includes a TMSA component T′. Data flows via this component to the central TMS 15. The scheme includes an instrument configuration management system (ICMS) 25, which manages policies for control of each instrument in the system. The policies include control or configuration information specifying, for example, the type of taggant that is to be read, the type of processing that is to be used to authenticate a particular taggant, the grade of user that is approved to use the reader, the workflow, that is the steps that a user who is operating the read has to take, and any other taggant reader information. Included in the ICMS 25 is a TMSA component T′, typically implemented on a secure application module (SAM) or some other tamper proof security component. Data flows via this to the central TMS 15. Each PoR reader/writer device 20,21 and PoA device 22,23 includes its own TMSA component T′.

In FIG. 2 one or more PoR reader/writer devices 20,21 may be linked/served using local networking such as WiFi or Ethernet, to a single Point of Registration (PoR) device 33, e.g. a client Personal Computer (PC) which also includes its own TMSA component T′. Similarly several PoA devices 22,23 may be linked/served in a similar manner by a main PoA device 35 e.g. a client personal computer (PC) which also includes its own TMSA component T′. In the description below references to the “PoA/PoR instrument 35” shall be understood to mean a PoA device or a PoR device or a single instrument in which a PoR and PoA device are combined.

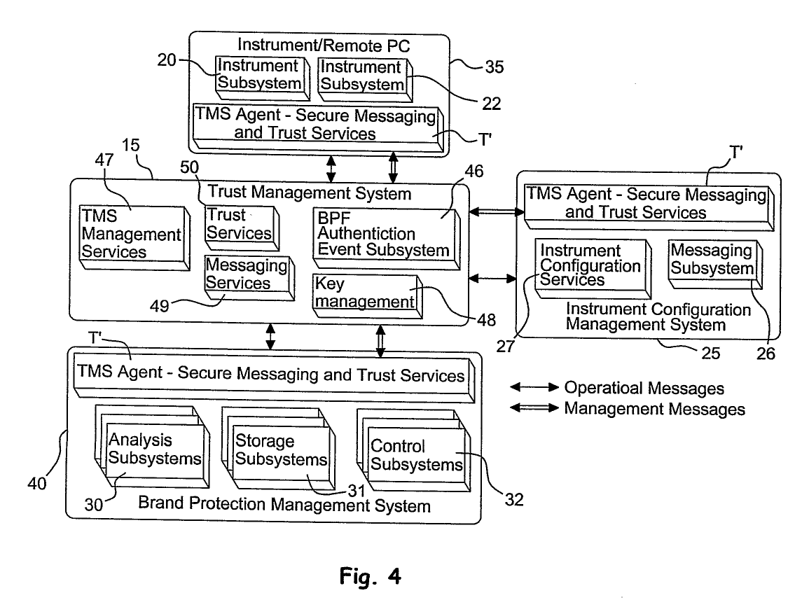

FIG. 3 is a schematic block diagram showing the main elements of the overall BPM scheme, namely the tagged product 36 to be authenticated/managed, a PoA/PoR instrument 35, the BPM service provider applications 37, including the TMS 15, brand applications 38 for implementing brand protection policies in the system, as well as Level 2 partitioning subsystems 39 of the BPM Service provider Applications. The PoA/PoR instrument 35 is responsible for reading and/or writing the taggant. It employs a taggant technology specific electronics module to do this, which module converts the taggant specific signals into a common data format for use in the BPM. Because all the taggant reader data is converted into this common format, the BPM platform is taggant agnostic; that is any type of taggant or taggant reader can be used, provided the taggant data can be converted into the common format e.g. a string data type. In the instrument 35 there is a trusted agent (i.e. is the TMSA) that is embodied within a physically tamper resistant domain, preferably a secure micro-controller. The trusted agent may be coupled very closely to the taggant technology specific electronics module or alternatively could be coupled to a main processor in the instrument 35, which processor communicates with the electronics module.

The trusted agent is intimately involved with all security related aspects of the reading or writing of the taggant. It stores a local copy of the brand owner's key and is employed in the authentication or registration of the taggant data. Other sensitive aspects of the brand owner's policies can be executed from within the trusted agent. For example the brand owner policy decision to go to a higher level of threat is set within the BPMS then communicated via secure messaging protocols through the ICMS 25 to the PoR/PoA 35 and eventually into the trusted agent. The trusted agent then executes that policy. This may involve, for example, directing the instrument to run a deeper level scan. Also if more than one taggant technology is employed on a particular brand owner's range of products the BPMS configures the trusted agent in the way required to run scans across these different taggants.

From the partitioning diagram of FIG. 2, it will be appreciated that the TMS 15 acts as the inter application mediator whenever exchanges of sensitive information are to be performed. It is also a trust environment for all information that requires differing degrees of security. The TMS Agents provide either the interface to the services of the TMS 15 or some of that functionality directly, if appropriate. Also, while the TMS 15 provides the central hub for secure application information interchange, there are situations where it is pragmatic for TMSAs T′ to interact with one another directly, for instance in the case of the BPMS 40 wishing to update brand protection policies residing on instruments. In this example, direct communication between the BPMS 40 and the ICMS 25 is more appropriate, and then between the ICMS 25 and the instruments. Thus, the agents of the TMS 15 present in those other systems have a high degree of functionality in order to achieve the required end-to-end security.

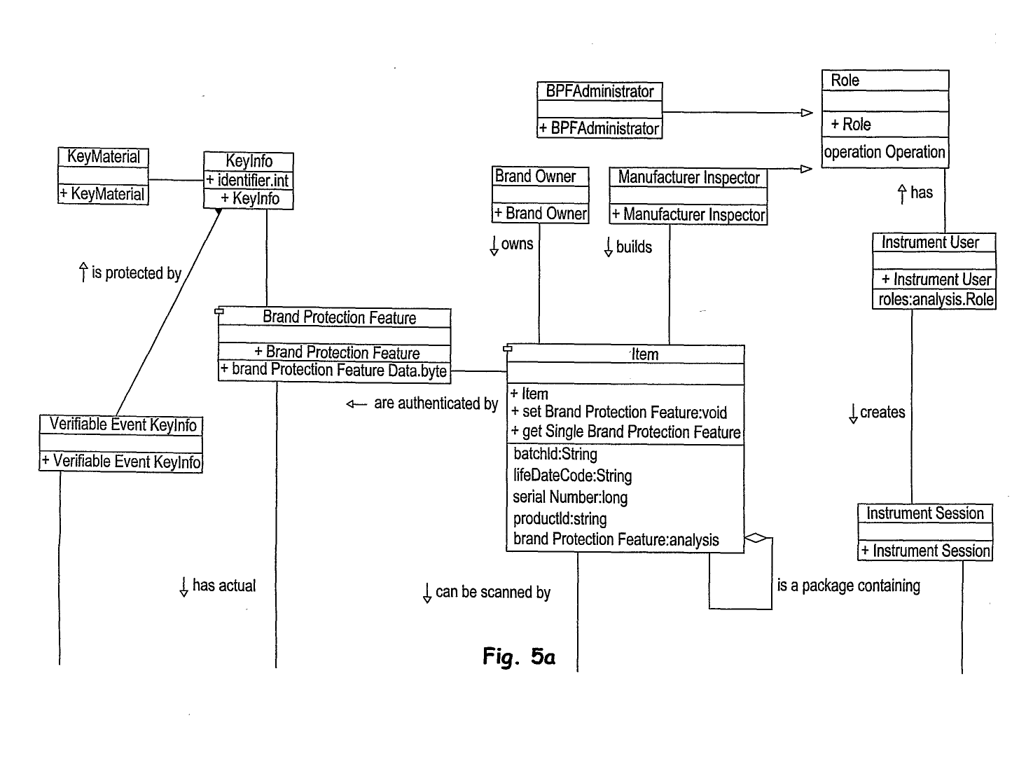

As well as communication mediation, the TMS 15 in this “level 1” partitioning is regarded as being the secure repository for all authentication event information. When considering a market model by which the brand protection system is not singular, but has several instantiations for different entities that may be interested in the event data, and possibly to different degrees of detail, it is practical to abstract this information into a trusted hub such as the TMS 15. An example of such a scenario can be envisaged in the pharmaceutical environment where not only the brand owner requires information, but also a regulatory body. The TMS 15 is also charged with ensuring that information is only sent to known, authorised entities. It will also ensure that those entities are permitted to receive only data to which they are entitled and which is intended for them.

Where the TMS 15 is acting as the mediator for secure communications, it must provide authentication and cryptographic services to meet these needs, as well as the related key management services. Thus, a key management sub-system 48 is provided together with a sub-system 50 providing “Trust Services”. This leads to the “level 2” partitioning of the system, as illustrated in FIG. 4. From this, it is apparent that the basic services, and hence the interface, to be provided by the TMS 15 to the other systems, have a very large degree of commonality. It is the message content that distinguishes the needs of the different interacting systems. In this connection, each TMS Agent T′ includes a secure messaging function. The ICMS 25 also includes a messaging subsystem 26, as well as an instrument configuration services sub-system 27. The TMS 15 further includes a messaging services sub-system 49, a management services subsystem 47 and a brand protection feature (BPF) authentication event subsystem 46.

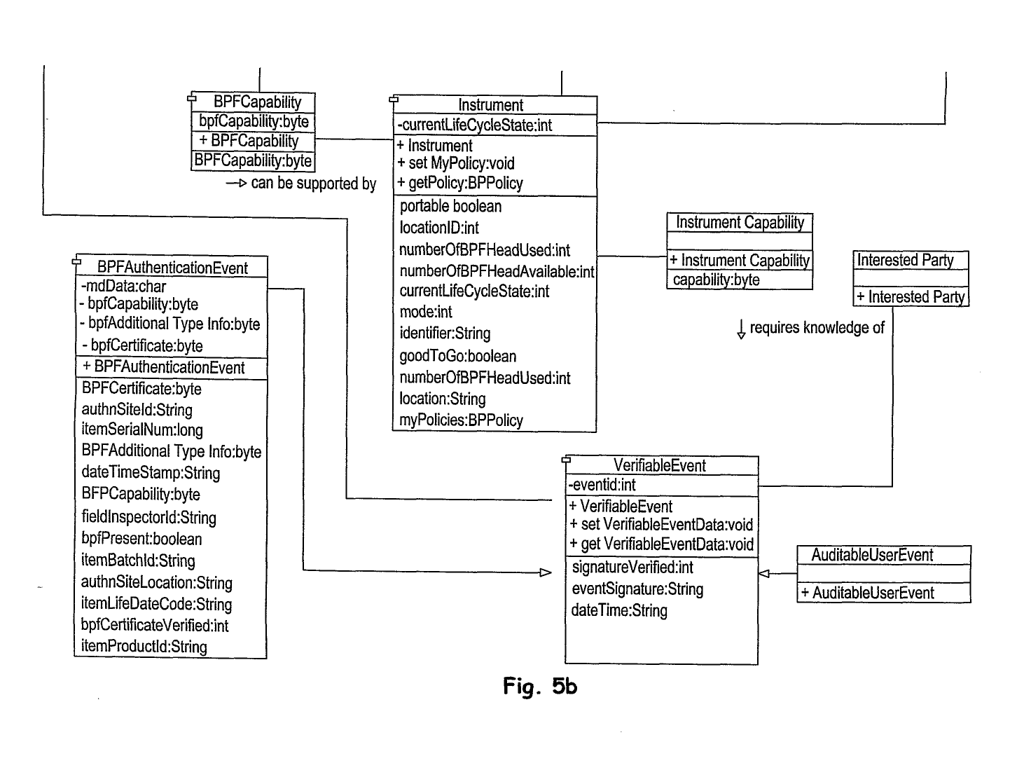

FIG. 5 shows various entities that are of importance for the MTMS. These are described in terms of their attributes (information for which the entity is responsible), operations if appropriate and relationships to other entities. In implementation terms, these entities tend to represent tables and columns in a database and are used to store information required by the enterprise. Table 1 below summarises the key entities identified in the class diagram of FIG. 5.

TABLE 1
Summary Description of Key Entites

| Class Name | Summary description |
|---|---|
| AuditableUserEvent | An event that may be subsequently verified that is not |
| | directly involved with brand protection. |
| BPFAdministrator | Entity associated with the management of a specific Brand |
| | Protection Feature (or feature set). |
| BPFAuthenticationEvent | Event details associated with authenticating a Brand |
| | Protection Feature as applied to an Item. |
| BPFCapability | Captures the capability of a specific Brand Protection Feature |
| | and of an Instrument. |
| BrandOwner | A BrandOwner is the interested party whose item is to be |
| | protected. |
| BrandProtectionFeature | The feature applied to an item, the reading of which provides |
| | the primary brand protection mechanism. |
| Instrument | This class encapsulates the properties of an Instrument. |
| InstrumentCapability | Identifies which Brand Protection Feature capability the |
| | instrument is able to verify or apply (write). |
| InstrumentSession | A particular session of system or user interaction with an |
| | instrument during which time items may have their Brand |
| | Protection Features applied or verified as authentic. |
| InstrumentUser | This is any user of the instrument: |
| | The BPF Administrator uses the instrument to *create* the |
| | BPF (or apply it to the item). |
| | The Field Inspector uses the instrument to perform item |
| | authentication. |
| InterestedParty | An actor or party who is not a direct user of the |
| | instrumentation or maybe even the Brand Protection System |
| | itself, but does require at least some of the information stored |
| | within the system. |
| Item | The object that is to be protected by a Brand Protection |
| | Feature and which has that feature applied and subsequently |
| | verified by an Instrument. |
| KeyInfo | The identifier for the key associated with, for example, a |
| | Brand Protection Feature on an Item. |
| KeyMaterial | This class contains the actual key data or values. |
| ManufacturerInspector | Builds/Manufactures/Creates the item to be protected. |
| Role | Encapsulates a role which may be assigned to certain users of |
| | the system |
| VerifiableEvent | A general event that can be verified |
| VerifiableEventKeyInfo | Key material (and reference) associated with a verifiable |
| | event for subsequent verification of the event after its |
| | creation. |

The TMS 15 provides generic services for all systems within the MST. The services required of the TMS 15 fall into two broad categories: operational services and management services. In terms of operational needs, the TMS 15 provides services to identify and authenticate users to the MST system; assign appropriate roles to the authenticated users of the MST system; provide cryptographic services such as data encryption and digital signature handling; generate, retrieve and verify brand protection feature authentication events; and retrieve and verify other verifiable events e.g. commissioning of an instrument. The TMS also ensures that the lossless nature of messages is preserved and that the appropriate security policies for the messages are managed and enforced. In terms of management needs, the TMS 15 provides to the BPMS 40 services to register and create new authentication details and associated keys, roles, brand protection features, capabilities etc.; manage existing user accounts, and retrieve audit logs for a particular account, product or range of item authentications.

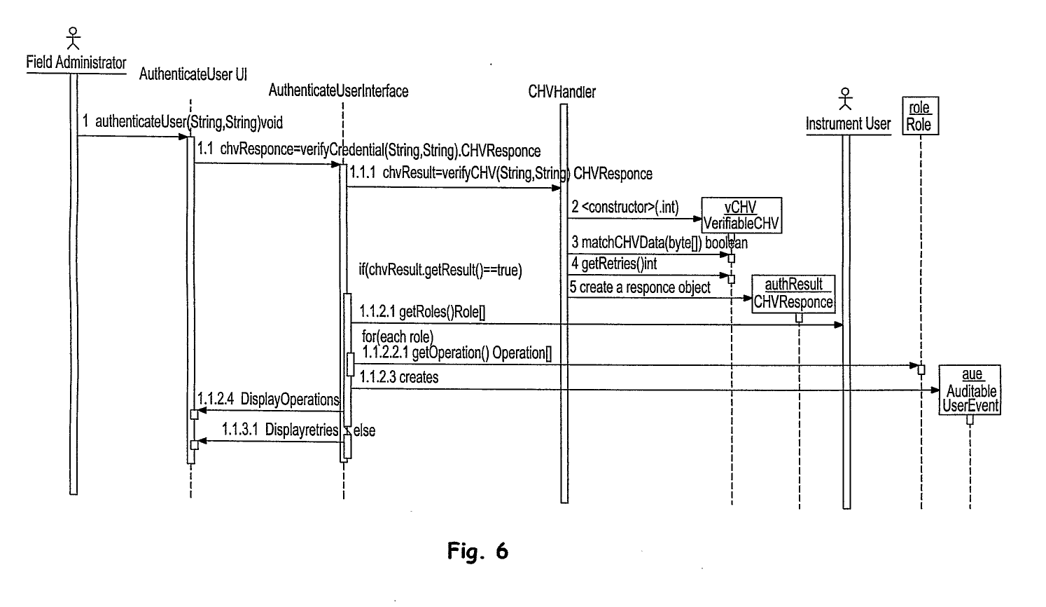

The TMS 15 authenticates that users have rights to access the MST scheme and ensures that those users only have access to the information and operations to which they are entitled. As an example of this, the sequence diagram of FIG. 6 shows the basics of such an authentication. While the diagram shows a field administrator actor in this instance, it should be clear that there are no differences in the services to be provided by the TMS system for other entities and actors. It must still verify the offered credentials and provide the role information for that user (if authenticated) to the system performing the subsequent actions. Thus, a User Authentication Manager class provides an interface to verify supplied credentials. This is offered by an interface verifiyCredential of the UserAuthenticationManager class. Based on the supplied credential, the manager class determines which of the available CHVHandlers should be called. There are different handlers for differing types of user authentication, be it user Personal Identification Number (PIN), fingerprint recognition, iris recognition, challenge/response authentication with a user's smart card or, as is most likely, a combination of some or all of these. Within the TMS 15 or its Agent, the appropriate CHVHandler then processes the request by constructing an object of the class VerificableCHV from the supplied parameter data. By comparing this with the expected CHV data via the internal matchCHVData operation, a decision may be made as to whether or not the user credentials are valid. If valid, the role information for the authenticated user is extracted, and, based on that role the relevant operations that the user is allowed to perform under that role are presented to the user via a user interface provided on the instrument 35.

One of the main functions of the TMS is to provide basic encryption, decryption and digital signature services to the other systems and entities in the MST system. These services are used, for example, to protect message payloads between entities for confidentiality and to provide non-repudiation of digital signatures used, for example, to provide originator authenticity when performing an item authentication or instrument configuration updates. The fundamental exposed interface to the cryptographic services is the interface class CryptoServicesInterface. The class CryptoOperationController implements this.

Another function of the TMS is to provide services to generate, retrieve and verify brand protection feature authentication events. The TMS and its agents achieve this using interface class BPFTrustServicesInterface. The class BPFServicesModule in turn implements this. In addition, the TMS 15 and its agents provide the means for the safe transport of brand protection policy updates and configuration changes. The representation of the brand protection policy is generalised to what may in fact be an abstract class, namely BPPolicy. In addition, the capabilities of a particular instrument are encapsulated in the class BPFCapability. Finally, the brand protection features themselves are also required throughout the scheme, so they too are summarised by a class named BrandProtectionFeature. The TMS 15 also provides services to generate, retrieve and verify “other” verifiable events, such as those that might be generated during instrument commissioning by a field engineer or by a brand protection administrator when performing an update to a brand protection policy over which they have administrative control. The TMS and its agents achieve this using interface class otherAuthServicesInterface, which is implemented by the otherAuthServicesModule class.

The TMS and its agents provide the means for the secure transport of messages e.g. those for brand protection policy updates and configuration changes. As it is the TMS and its agents that have knowledge of the cryptographic keys associated with the interacting actors and systems, it is this system that provides the operations to transfer information between the systems. The fundamental exposed interfaces to the messaging services are the interface classes MessageReceiverInterface and MessageSenderInterface for the processing of incoming and outgoing messages respectively. The class MessageReceiver implements the former, while the class MessageStoreManager implements the latter.

As described above, the TMS 15 provides operations to users of the appropriate role to administer user accounts. The fundamental exposed interface to the user Management services is the interface class userManagerInterface, which is implemented by the class userManager. The TMS 15 also provides operations to users of the appropriate role to retrieve audit information for a particular account, product or range of item and specifically their authentications. It also provides system status information. For the former of these, there are again limited specific requirements as to the data to be extracted. Such reporting is tailored for specific implementations and/or brand owners or other interested parties.

Updating of policies, features or the capabilities of a distributed instrument base is done by the ICMS 25. Fundamentally, the ICMS 25 is responsible for the overall configuration of an individual or group of instruments and their trust agents; the life cycle management of the instrument(s) and their trust agents and the health monitoring, status and fault reporting of the instrument(s) and their trust agents. Whilst the TMS 15 and its Agents T′ provide the base cryptographic services in order to guarantee authenticity and validity of the messages passed between the systems, the ICMS 25 has sole management and knowledge of the configuration of the installed instruments, and uses this information together with the TMS 15 to ensure that the appropriate keys are used to perform updates, installations, policy or other configuration changes to those instruments.

Deploying policies through the ICMS provides a means for managing what will typically be thousands of instruments. Not all instruments will have the latest version of the policies. With a policy potentially being delivered to different groups of instruments at different times, or as different versions, the system needs to include the concept of the “deployment” in its own right; that being an occurrence of a policy being delivered to a particular group of instruments. In order to manage this, the ICMS includes a deployment manager, which is responsible for planning where and when policies are deployed and also keeping a record of which policies and which version of these policies have been deployed, so that a full deployment history is available giving a full and complete picture of the policies in system in the past, present and future.

The TMS 15 and its Agents T′ provides the means for the safe transport of brand protection policy updates and configuration changes from the ICMS to the relevant instruments. The interface class InstrumentManagementControllerServices provides the fundamental exposed interfaces to the services of the ICMS, and this is implemented by the class InstrumentControllerServices. Other services may be required of the brand protection management system 40 either directly or a BPMS application running on the ICMS 25, POA/POR 20-23 and Instrument 35. The TMS15 could potentially manage these services, but to maintain separation of roles, a separate entity that itself made use of the cryptographic services of the TMS would be more appropriate. These brand protection specific services are detailed below.

While the above indicates the interfaces used, it is also necessary to detail the minimum message contents for each of the message classification so far identified. This is achieved via XML compliant schemas. The schemas provide the core information and example values where appropriate, but are not in themselves prescriptive as it would be expected that any implementation would have its own rules that would prescribe the inclusion of additional elements and/or may change the limits described herein. Not all possible message or event types are here described. However, the variation required for the other messages is limited, and will be implementation specific. For these reasons, it is deemed more important to give examples of the different types of messages expected to ensure that the essence of the requirements were captured for all such messages and events.

Interactions between the instruments 35 and the TMS 15 are defined by Operational Level Messages including: upload and verification of batches of authentication events from points of authentication/registration and/or instruments 35 to the TMS, either at the instigation of the TMS or the instruments, and acknowledgement messages to the points of authentication/registration 20-24 and/or instruments 35 from the TMS to allow data management within those entities, thus allowing further authentication operations to occur.

Interactions between the ICMS 25 and the instruments 35 are defined by Management Level Messages including: (a) update management keys: rollover, update, replace or otherwise index an alternate set of keys to be used for management of the instrument/point of authentication/registration; (b) update policy/configuration data (e.g. enable secondary feature authentication and/or perform secondary scan of “alternate depth”)—the content of any such update message will be dependent on the configurable capability of individual instruments, details of which are stored by the ICMS 25; (c) retrieve configuration data: read the current configuration information; (d) commission instrument: while this may be considered a special case of update, it may well have additional information that allows the life cycle management to occur, and (e) life cycle management: messages to activate, suspend and re-instate instruments and/or their associated TMS agents T′.

Key management is satisfied by the TMS 15 and not the ICMS 25. While the ICMS may provide the required routing, it is the TMS that provides the key management. Such sensitive key management is also dependent on the detail of the underlying platforms chosen to implement the key generation and management technology. In this embodiment however, the importKeySet interface as defined for the CryptoServicesInterface provides sufficient functionality by overwriting, adding or replacing any keys requiring removal or updates. The Retrieve Update Policy and Configuration Data services are provided by the InstrumentManagementControllerServices interface of the ICMS. The PoA/PoR 35 supports an equivalent interface to process the generated messages. The commissioning services are provided by the processInstrumentCommissionMsg operation of the InstrumentManagementControllerServices interface of the ICMS 25. The PoA/PoR 35 supports an equivalent interface to process the generated messages. The life cycle management services are provided by a combination of the processInstrumentCommissionMsg operation and the processInstrumentConfigMsg of the InstrumentManagement ControllerServices interface of the ICMS as defined before. The instrument 35 supports an equivalent interface to process the generated messages.

To support these interfaces at the instrument 35, an InstrumentCommissioningController class has been identified. This class abstracts the currently perceived processing required. On the instrument, this class processes an InstrumentCommissioningMessage. This may trigger updates to any of the following entities: BPF capability; brand protection feature; key information; key material; brand owner and instrument management key. In addition, there is a reciprocal interface at the BPMS 40 to allow the brand owner to configure this data for the instrument 35 or relevant group of these. The message formats used for conveying commissioning and configuration data are very similar to those described for transporting the brand protection feature authentication event 46 data. They inherit from the generalised message schema and extend that with their specifics.

The TMS services required by the instrument 35 are no different than the services required by the other systems in terms of user authentication or cryptographic capability. Hence, the interfaces described previously define everything of the TMS agent T′ that might be required by the instrument 35. However, the instrument based TMS agent is not solely restricted to user authentication and cryptographic services. The brand protection feature authentication services 46 described above may also be performed by the instrument based TMS agent or a brand protection specific equivalent within the instrument platform. While the interfaces described are language agnostic, they suggest at least a third or fourth generation language application programming interface. While this is entirely possible on the instrument platform, the implementation of the TMS agent needs to include a secure application module (SAM), in order to offer the required security assurance level for the system. Use of such a module does not preclude also providing the described interfaces, but the SAM can provide the sub-system services.

Using SAMs in the instruments and the server provides a number of significant technical advantages. For example, it enables tamper proof communications between the instruments and the server. It also allows within instruments secure local, off-line validation of brand protection features containing an encrypted check such as a MAC and secure processing of certain elements of a taggant, for example location of pertinent second order features within a barcode. The instrument based SAM also allows secure recording of event records and stamping of records with time, location, workstation etc and secure execution of a policy or workflow, for example to ensure that all required steps have been complied with.

There is a well defined set of specifications for SAMs and other Integrated Circuit Cards (ICC) that detail the electrical signals, communications protocols and Application Protocol Data Units (APDUs) that all such modules should be compatible with. The relevant ISO 7816 specifications are detailed in the following references: ISO/IEC ISO 7816-1, Identification cards—Integrated circuit(s) cards with contacts—Part 1: Physical characteristics, 1998 (Amendment 2003); ISO/IEC ISO 7816-2, Identification cards—Integrated circuit cards—Part 2: Cards with contacts—Dimensions and location of the contacts, 1999 (Amendment 2004); ISO/IEC ISO 7816-3, Information technology—Identification cards—Integrated circuit(s) cards with contacts—Part 3: Electronic signals and transmission protocols, 1997 (Amendment 2002); ISO/IEC ISO 7816-4, Identification cards—Integrated circuit cards—Part 4: Organization, security and commands for interchange, 2005; ISO/IEC ISO 7816-8, Identification cards—Integrated circuit(s) cards with contacts—Part 8: Commands for security operations, 2004, and ISO/IEC ISO 7816-11, Personal verification through biometric methods, 2004.

ISO 7816-4 details the interfaces offered by ICCs to satisfy the user authentication services. ISO 7816-8 details the interfaces offered by ICCs to satisfy the basic cryptographic services. However it should be noted that there are many schemes already in existence that perform operations such as “transaction generation” that do not require these features. They instead extend the user authentication services of H.2 and/or use proprietary extensions to the APDU interface to simplify that interface. One example is that the internal authenticate interface, which is often used for digital signature generation, while the external authenticate interface is used for the reciprocal verification.

A number of interactions by actors within the BPMS 40 require other operations of the systems to be instigated. For example, the BPMS 40 presents the brand administrator with an interface to allow him to configure the capabilities and configuration of the instruments 35 that he/she wishes to commission in order to perform BPF authentications. In addition, the BPMS includes a policy editor to allow policies to be changed, for example up-dated, as and when desired by the brand administrator. Examples where the BPMS 40 requires services of the ICMS 25, and so for which there are reciprocal services within the BPMS 40 include: preparation of brand owner supplied commissioning information for a particular intended recipient; requests by the BPMS for the ICMS to protect messages for points of authentication, instruments or TMS agents in order to, for example, update or otherwise modify a brand protection policy on an instrument; request to associate a possibly new brand owner with an existing group or other subset of the instruments; request to associate a possibly new item or brand owner product with an existing group or other subset of the instruments. The TMS 15 and its agents T′ as defined previously provide the cryptographic and messaging services required by the BPMS 40.

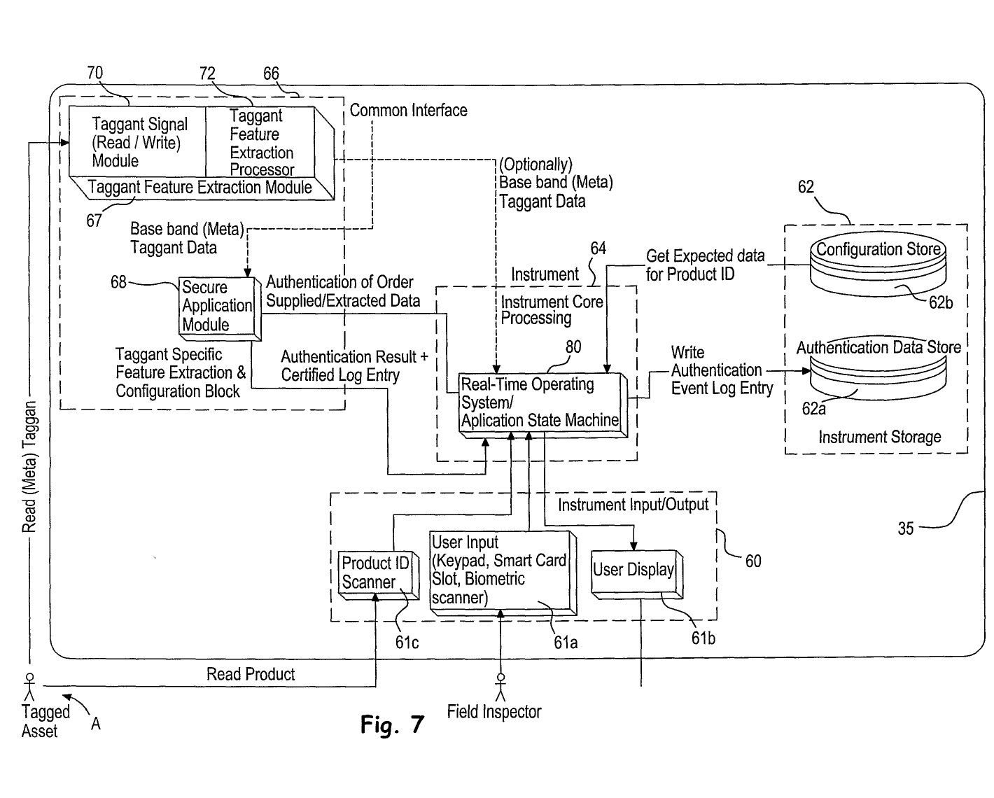

FIG. 7 is a schematic block diagram illustrating an embodiment of the instrument 35. This includes an input/output module 60, an instrument storage facility 62, a core processing function 64 that is implemented on a core processor 80 and a taggant specific feature extraction and configuration block 66 incorporating a taggant feature extraction module 67. Also provided is a tamper resistant secure application module (SAM) 68, such as a smart card, which is the acting TMSA and includes secure information for authenticating taggants using, for example, taggant features that have overlapping verifiable content, such as an encrypted check such as, a MAC. Between the taggant specific feature extraction and configuration block 66 and SAM is a common taggant process for converting taggant specific data into the common platform format. This is a logical process that is run on the core processor 80. Optionally this functionality may be provided within the taggant feature extraction module 67.

The input/output module 60 has a user input 61a, which may be, for example, a keypad, smart card slot or biometric scanner, a user display 61b and a product ID scanner 61c, which could, for example, be a barcode scanner, an RFID tag reader or any other chosen machine readable taggant reader device, for reading a taggant asset in order to extract identification information relating to the asset. The core processor is a real-time operating system/application state machine 80 and controls all processing operations in the instrument 35. This communicates with the SAM 68, data stores 62a, 62b and the components of the input/output function 60. The instrument 35 is provided with an interface, which may be ISO7816 or USB (not shown), for communicating via the SAM 68 with the TMS 15, which may be physically located on a different geographical site to the instrument 35.

The taggant feature extraction module 66 incorporates a taggant signal or read/write module 70 and a taggant feature extraction processor 72. The read/write module 70 is used to read security data, which may be authentication data or some type of security taggant data from one or more machine readable taggants applied to the asset being authenticated. The read/write 70 module may be operable to read different types of taggants, for example it may have a reader head that is able to read two or more of UV taggants, RFID taggants and simple bar code taggants. This taggant may be the same taggant as that which contains the product ID data to be read by the product ID scanner 61c. For example, covert security data may be contained in the ID tag of the asset or may be an additional or “meta” taggant applied to the asset e.g. upon creation/packaging of the asset. The raw data from the taggant read module is processed by the taggant specific feature processor 72.

Included in the processor 72 is a plurality of different processes for use with different taggants, ideally three or more different processes. For example, the processor may be able to handle data read from a 1D bar code, a 2D bar code, a UV reader and an RFID tag and one or more covert features. Equally, the processor may be able to apply different processing functions to specific types of taggants. The type of processing used may be determined by user selection of a particular tag or may be enforced in accordance with configuration data downloaded from the ICMS 25. This configuration data can be reconfigured as and when desired, for example in the event that a particular taggant is compromised. Taggant specific data captured or extracted by the taggant feature extraction module is converted by the common taggant process (not shown) into a common format that can be processed by the BPMS server.

The instrument storage facility 62 includes a data store 62a for converted authentication data and a data store 62b for configuration data, which sets the configuration of the taggant feature extraction module 67. The configuration data is downloaded via the ICMS 25. The ICMS 25 is instructed by the BPMS to update this data to a set of instruments. The configuration data can be signed by the TMS. This configuration data is generally sent in the form of one or more brand protection policies that are to be executed by the instrument 35. The configuration details include product IDs, authentication events, their parameters, their sequencing, what taggant technologies are to be used, and whether there is a link between data read from one taggant and another on the same product. Sensitive information is sent to the SAM 68 where it is stored securely. None of the TMS, ICMS 25 and BPMS controls the instrument's activities directly, but they do manage them. In this way decision-making is delegated into each instrument 35 but all events are securely recorded and uploaded for analysis later by the BPMS.

In this embodiment, the product ID is obtained using the scanner 61c and used to identify from the configuration data store 62b the required configuration of the feature extraction module 67. This configuration determines what taggant feature or features the instrument will extract/read from the tagged asset. The data extracted from the identified taggant is used by the SAM to authenticate either that or another taggant. The authentication data store 62a is used to temporarily store data on events such as those authenticated by the SAM, where the instrument is being used in an offline capacity with respect to the TMS system 15. This stored authentication event data can then be uploaded to the TMS 15 for verification and analysis when the instrument is again “online” with the TMS central server. As described previously, the database 10 of the MTMS contains stored authentication data. In practice, the uploaded data will be compared with the stored data in order to recognise a user and/or taggant as authentic, or deny system access/generate an alarm signal if the uploaded user or taggant authentication data does not match the relevant stored data. In this way a two stage check, is provided, firstly by conducting an offline authentication using the SAM and secondly by cross checking the data at the server.

In use of the instrument 35, the user identifies themselves and the type of taggant that is to be used, so that the taggant specific processor is able to identify the processing needed for the taggant that is about to be scanned. Then a signal comes in to read/write module 70, goes through the taggant specific first level processing in processor 72, is converted into the common data format and sent to the SAM 68 for examination for authenticity, thereby to provide off-line authentication of the taggant. Then a secure record of the event (pass/fail/date/time/operator etc.) is created in the SAM 68, by signing or encrypting it. The secure data is stored in data store 62a and a header associated with that data is stored in the SAM. At a later time, on behalf of the BPMS, the TMS 15 asks for all such records to be up-loaded. This is done via the secure TMS connection, so that the integrity of the data can be ensured. Once the date is received, at the TMS 15, a confirmation signal is returned to the instrument 35 and the temporary memory 62a is cleared. The BPMS then examines the records from a macroscopic perspective to check that everything is in order. This may involve trying to identify event patterns that are indicative of suspicious activity.

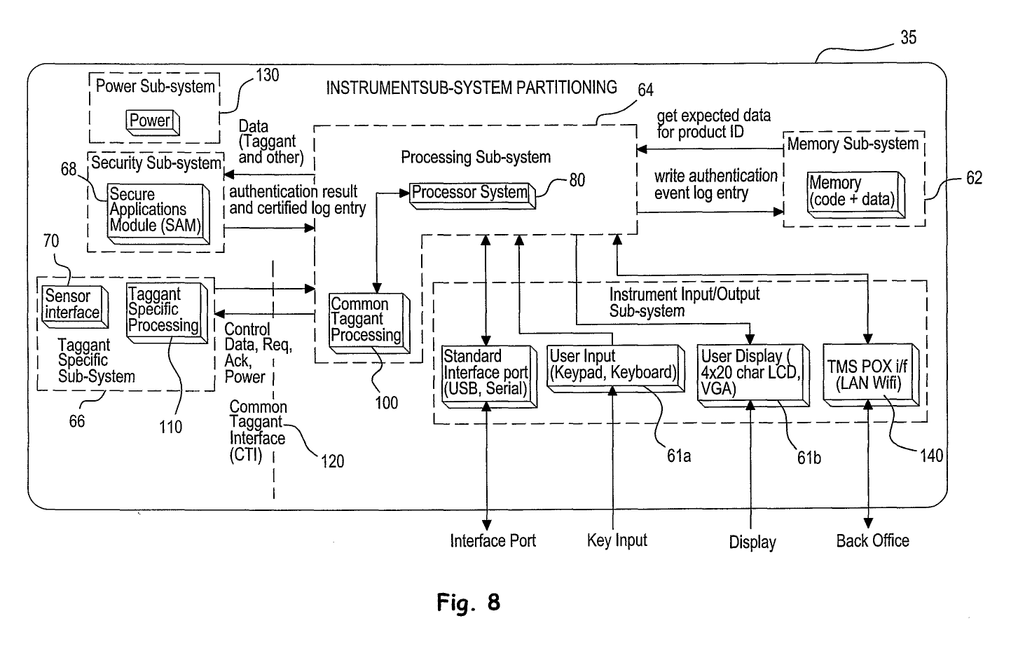

FIG. 8 shows an alternative embodiment of the instrument 35 of FIG. 7. In this, the SAM 68 is provided separately from the taggant technology specific sub-system 66 which may itself be in the form of a separate hand-held unit, incorporating taggant reader means in the from of a scanning or sensing head (not shown). In this case, the core processing function 64 is provided by a main processor system 80 and a common taggant processing module 100, which may, if desired, be provided in the main processor 80. The common taggant processing module 100 communicates with a taggant specific processing module 110 in the taggant specific subsystem 66 via a common taggant interface 120. The common taggant interface 120 is the interface between the common taggant processing module 100 and TSP 110. It provides the logical and physical interface for the core modular instrument 35.

The common taggant interface 120 allows the following control, messaging and data transfers: configuration; activate/de-activate (stimulus); read (data/parameter/qualifier); write (data/parameter/qualifier); status (ready/not ready); fault (error code); request and acknowledge. Power from a sub-system 130 is supplied over the common taggant interface to the taggant specific processing module 110. The instrument also has a communication interface 140 for two-way communication with the central TMS system 15. The common taggant interface 120 allows common data to be passed to the common taggant processing module 100, for further processing in the processing system 80 and subsequently by the SAM 68 and/or TMS system 15. By common data it is meant generic data, not specific to the taggant technology of the particular taggant reader head being employed to read/scan the taggants, extracted by the taggant specific processing module 110 from the taggant technology specific data produced at the sensor interface 70. An SPI based interface is used to provide a flexible communications channel between the CTP 100 and the sub-system 110 over the common taggant interface 120. This allows command and data transfers in both directions and it allows either side to initiate communications, as long as the SPI device is enabled.

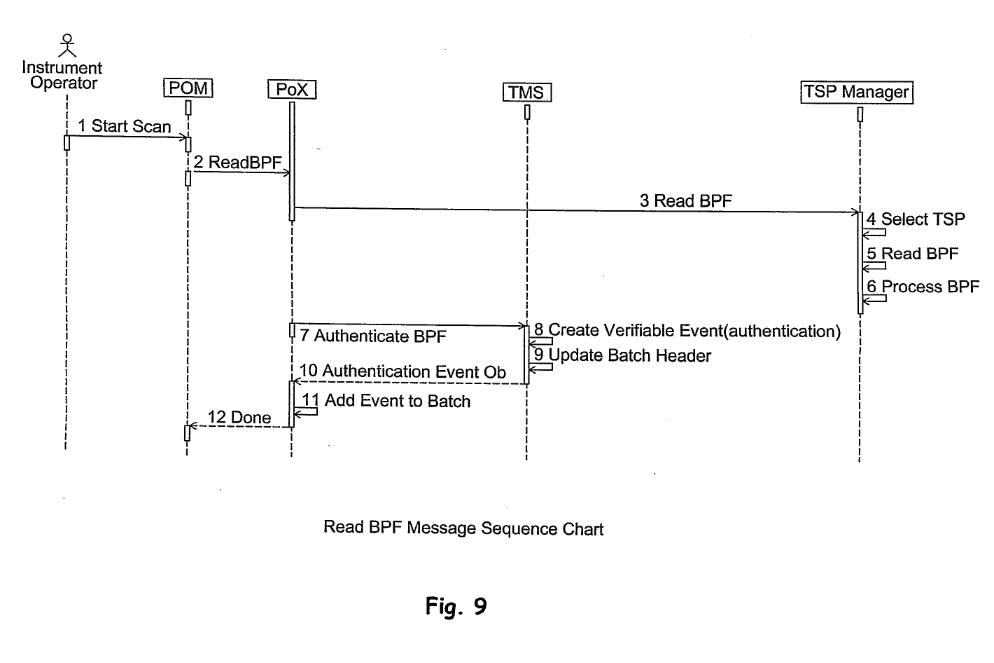

FIG. 9 summarises the high level steps taken when a taggant is to be authenticated. This can be implemented by either or both of the instruments of FIGS. 7 and 8. Here an initial instruction is received by a policy object manager (POM). This is a software application that is run on the instrument's core processor and initiates the taggant read or write. A signal is sent to an interface (PoX) with the taggant reader to cause the required raw taggant data to be captured. The raw data is sent to the taggant specific processor, where the relevant taggant specific configuration data is identified, for example specific information, on the type of processing that is to be done. The taggant specific data is then read and processed, for example a bitmap image captured of a barcode might be converted into the value represented by that barcode. The processed data is forwarded to the TMSA in the SAM, where the taggant is authenticated. In the event that the authentication is successful, a verifiable authentication event is created, and stored in a batch of other such events. Preferably, the data for each authentication event is signed or encrypted by the SAM before being stored. At this stage, the user of the instrument may be notified that the taggant has been authenticated. The batch is then later transferred to the BPMS when the instrument is next on-line, where the authentication data can be crosschecked, if necessary.

The system in which the invention is embodied can be adapted in real time and so can respond quickly to security threats. In particular, it provides a system through which major breaches and/or threats can be anticipated, resolved and effectively managed. The steps in the procedure for identifying a major fraud usually start with a suspicion that a fraudulent event is suspected and identified. A new policy or specific configuration data can then be created for downloading to readers, thereby enforcing a change, which prevents the fraudulent activity. For example, in the event that it is suspected that a taggant has been compromised, the new policy may include the up rating of that taggant. Additionally or alternatively, the reader can be caused to read a different taggant on the article or to switch to a different type of processing or use different combinations of taggants. The new policy may also provide local alerts to local supervisory staff or redirect policies to other sources if supervisory staff is suspected. The new policy is distributed to one or more selected instruments in one or more selected areas.

As well as providing a mechanism for responding to fraud, the MST can be used to help in the recall of products. Although product recall may be seen as the last resort it is an essential part of the armory to protect a supply chain and ultimately end-consumers particularly in safety critical market sectors. Today product recalls are costly, difficult and slow processes requiring significant manual intervention, communication by numerous media and painful pouring through records both written and on various and different computer systems, Delays and uncertainties over the completion of the recall are in themselves dangerous. This is a particular concern in the pharmaceutical industry.

When a problem is identified, the brand owner serial numbers of the problem products have to be identified. Where necessary, for example in the pharmaceutical industry, the brand owner assesses problem and contacts Regulator. If necessary product recall is then initiated by brand owner/regulator. As part of the recall, the BPMS data is searched to locate where in supply chain the problem product or products were last seen. If the last known location is not recent or is unknown, other potential locations are identified. Contact details for locations to alert are then extracted from the database and then identified and an alert notice is sent, together with information on the product, product, batch number(s) etc.

Where a product is still within the remit of the manufacturer's BPMS, or a cooperating system, recall information may be communicated to relevant instruments in the supply chain, so that when scanned, the recalled status can be brought to the user's attention and the product recalled. Communication of the recall alert will reflect the level and completeness of detail available. For example, it may be to one or more companies currently holding the relevant product or at a higher level to a country regulator with any available information on entry point and likely recipients. Recalled items are tracked as and when they are retuned and scanned by the manufacturer. By storing data on the progress of product recall, the current situation is visible to Regulator and trusted parties for example the percentage of products recalled can be tracked.

Further variations, modifications and improvements are possible within the scope of the invention. For example, it will be appreciated that within the BPM scheme there may be several instruments 35. In one possible embodiment the central server system is able to set watchdogs in the instruments 35 where there is a high perceived threat. For instance, a particular model of product that has been a target of counterfeiters might have a watchdog set in each instrument 35 by the TMS in the central server that immediately alerts a central investigation team, for example, by e-mail, once that model is detected.

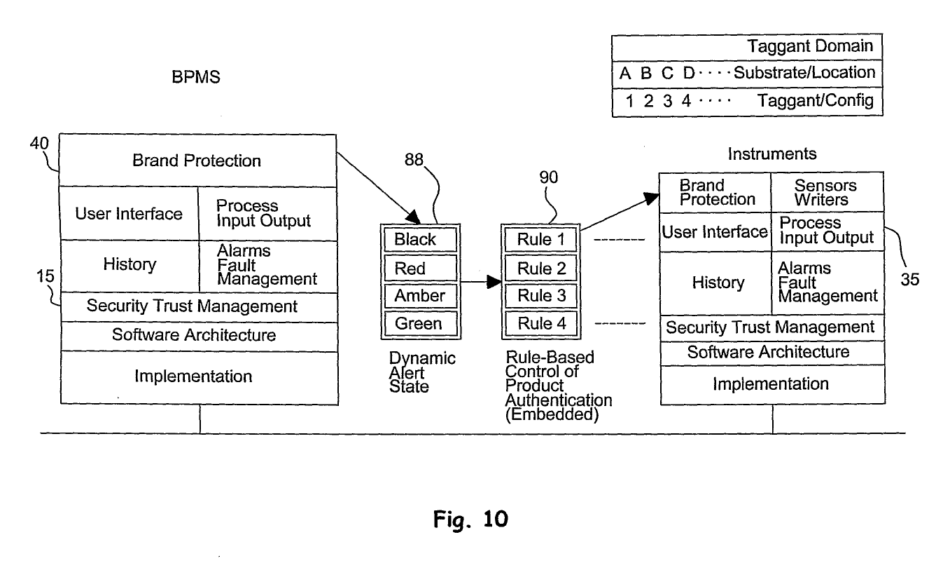

FIG. 10 illustrates a possible such dynamic alert state system operating in conjunction with the TMS system 15. This may form part of the BPMS 40. In this dynamic alert state system there are four possible alert states, descending in order of priority from Black, to Red, to Amber, to Green. The alert state 88 is set/chosen by the BPMS or TMS depending on user input and/or automatic state resets triggered by alert/alarm signals generated in one or more of the instruments 35. Changes in alert state may result in changes in the operational behaviour of the BPMS 40. For example, an instrument 35 may be capable of reading multiple overt/covert taggants on a product, and a change to higher alert state may result in additional taggants being used to authenticate product. Alternatively or additionally, a change in alert state may change how the system reacts if an authentication event fails. Changes in behaviour of the brand protection system may not be visible to operator of the instrument.

The BPMS 40 includes declarative language for describing brand protection policies. This language describes the different types of alert state and how they control the behaviour of the brand protection system. The brand protection policy language is built into the MST platform as a technology element thereof. The brand protection management functionality converts changes in high-level policy information into changes in behaviour of lower-level system components. For example, the instrument 35 contains a rule-based engine 90 that controls the level and sequence of product authentication actions based on local state and event information; product authentication rules in instrument are dynamically updated based on changes in brand protection policy and alert state.

The platform in which the present invention is embodied provides numerous technical advantages, and is an invaluable source of information that can be used to track and authenticate articles. The system can be applied across multiple industries using multiple different taggant technologies, in a manner that can be adapted and reconfigured to suit changing business or security needs. The system allows multiple articles to be scanned and authenticated at multiple different locations, for example multiple geographic territories. This allows the system to monitor patterns of activity that otherwise would be impossible to do. This is of particular value to large organisations, such as pharmaceutical companies, as authentication events from all over their markets, typically all over the world, can be monitored to identify fraudulent or suspicious activity as early as possible.

A skilled person will appreciate that variations of the disclosed arrangements are possible without departing from the invention. Accordingly the above description of the specific embodiment is made by way of example only and not for the purposes of limitations. It will be clear to the skilled person that minor modifications may be made without significant changes to the operation described.

1. A system for authenticating articles comprising:
an authentication manager for managing authentication information associated with the articles;
a plurality of secure taggant reader instruments for reading machine readable taggants associated with the articles, the taggants including the authentication or related information, and an instrument configuration manager for secure on-line configuration of the instruments, wherein the taggant reader instruments are operable to securely process and send authentication information derived from a taggant to the authentication manager and the authentication manager is operable to use the received authentication information to identify suspicious events.

2. A system as claimed in claim 1 wherein the instrument configuration manager is operable to reconfigure at least some of the taggant reader instruments in response to one or more of the following: identification of suspicious events; a product recall; comprise of any aspect of security; compromise of taggant security; taggant up-date; change in any on-board taggant reader process; change in any instrument based cryptographic key.

3. A system as claimed in claim 1 wherein the instrument configuration manager is operable to configure one or more of the following taggant reader functions: type of taggant to scan; the order in which features are to be scanned; the type of processing to use to determine authentication information; where more than two taggants are on the article, which combination of taggants is to be used; the status and/or identity of the person authorised to use the reader; one or more cryptographic keys for use in the taggant reader instruments in accordance with a key management scheme.

4. A system as claimed in claim 1 wherein a record of a taggant reader's configuration is stored as a function of time, so that a complete record of the reader's status and functionality is retained.

5. A system as claimed in claim 1 wherein at least one of the taggant readers is operable to determine the authenticity of an article using information read from the machine readable taggant and the authentication information sent to the authentication manager is indicative of the determined authenticity.

6. A system as claimed in claim 1 wherein the authentication information sent to the authentication manager allows the authentication manager to determine authenticity of the article.

7. A system as claimed in claim 1 where the authentication information includes an indication of the time of capture of the taggant information and/or the person responsible for the reader at the time of capture.

8. A system as claimed in claim 1 wherein at least one taggant reader, preferably all the taggants readers, includes at least one tamper resistant secure application module for controlling the processing of sensitive information and/or communication of sensitive information to and from the taggant reader and/or authenticating users.

9. A system as claimed in claim 1 wherein the instrument configuration manager is operable to configure or reconfigure instruments individually and/or in designated groups and/or all simultaneously and/or after a designated period of time.

10. A system as claimed in claim 1, wherein the or each instrument is configured to communicate with the authentication manager via the internet.

11. A system as claimed in claim 1, wherein at least one of the taggant readers include means for generating taggants to be applied to articles to be authenticated.

12. A system as claimed in claim 11 wherein the instrument configuration manager is operable to determine the taggants that are to be applied and send control signals to the taggant reader instruments to ensure that the determined taggant is applied.

13. A system as claimed in claim 1, wherein at least one of taggant readers comprises a plurality of instrument heads, each head being formed and arranged for scanning and/or detecting a different type of taggant.

14. A system as claimed in claim 13, wherein one or more of said instrument heads is replaceable.

15. A system as claimed in claim 13, wherein a common interface is provided to allow communication of data in a common format between the taggant readers and the authentication manager, so that the system is independent of the taggant technology used.

16. A system as claimed in claim 15 wherein the common interface is provided in each taggant reader.

17. A system as claimed in claim 15 wherein the common interface is provided remotely of the taggant reader.

18. A system as claimed in claim 1, wherein the taggant readers are configured to read inherent features of the articles to be authenticated, which features are used as machine readable taggants.

19. A system as claimed in claim 1, the taggant readers are located at different physical locations.

20. A system as claimed in claim 1 comprising a trust management system for ensuring security in all communications between the instruments, the instrument configuration manager and the authentication manager.

21. A system as claimed in claim 20, wherein the trust management system is distributed and each taggant reader includes an agent of the trust management system for securing all communications between the taggant readers, the authentication manager and the instrument configuration manager.

22. A system as claimed in claim 20, wherein the trust management agent is configured to encrypt or sign communications between the taggant reader and the authentication manager.

23. A system as claimed in claim 1, wherein each taggant reader is capable of operating in an online state and/or an offline state.

24. A system as claimed in claim 1 comprising means for tracking interactions with the system of personnel responsible for handling said articles.

25. A system as claimed in claim 24, wherein said means for tracking interactions comprises user input means for obtaining user identification information physically associated with a user of the system.

26. A system as claimed in claim 25, wherein said user input means comprises barcode scanning means.

27. A system as claimed in claim 25, wherein said user input means comprises one or more of the following: SMART card/chip reader means; token reader means; biometric scanning equipment; a user input keypad.

28. A system as claimed in claim 25, wherein said user input means comprises a plurality of user input means for location at different physical locations.

29. A system as claimed in claim 25, wherein the or each said user input means is provided in the same instrument as the or each said taggant reader means.

30. A system as claimed in claim 1 comprising means for comparing input user identification information with user authentication data stored in the authentication manager, whereby a user can be authenticated.

31. A system as claimed in claim 1 comprising a trust management system (TMS) having a plurality of functional modules comprising a brand registration and administration module configured to allow operational data to be entered; a brand owner key management sub-system configured to allow brand owner article identification information and/or verification key information to be entered and amended in the database means; a brand owner key management sub-system configured to enable brand owners to authorise and authenticate personnel who handle articles to be authenticated, and to verify event records generated and/or signed by said personnel; a system administration module configured to provide information on the status of the database means and/or content of the database means; and an authentication sub-system module configured to provide authentication functions and security functions.

32. A system as claimed claim 1 comprising means for detecting one or more different alert states.

33. A system as claimed in claim 32 wherein the means for detecting an alert are located at and/or remotely from the taggant reader.

34. A system as claimed in claim 33 configured to perform a predetermined action upon detection of an alarm signal.

35. A system as claimed in claim 33 wherein upon detection of an alarm signal, the instrument configuration manager reconfigures at least the taggant reader at which the alarm was detected.

36. A system as claimed in claim 35, wherein the taggant reader is reconfigured to read a different type of taggant and/or a different taggant feature associated with the articles being authenticated.

37. A method of authenticating articles comprising the steps of:
storing authentication information relating to the articles;
reading machine readable taggants physically associated with said articles;
extracting generic authentication information from taggant technology specific data read from said machine readable taggants; and
comparing said extracted generic authentication information with said stored authentication information, so as to determine whether said articles are authentic or not, whereby a multiplicity of different taggant reader means utilising different taggant technologies may be used for reading respective different types of taggants.

38. A system for authenticating articles that bear one or more machine readable taggants comprising:
management means for managing authentication information relating to the articles; and
means for receiving data from a plurality of different taggant readers operable to read different taggants or types of taggants and means for providing the data from the multiple reader devices to the management means in a generic or common format.

39. A system as claimed in claim 38 wherein the means for providing information in a common or generic format are provided in at least one of the taggant readers.

40. A system as claimed in claim 39 wherein means for providing information in a common or generic format are provided at an interface with the management means, so that data received from the taggant readers is converted into the common format.

41. A system as claimed in claim 38 wherein at least one reader is operable to authenticate a taggant and provide generic information that is indicative of whether the taggant is authentic.

42. A system as claimed in claim 38, wherein at least one reader is operable to provide information that allows the management means to determine whether a read taggant is authentic.

43. A system as claimed in claim 38, wherein each reader includes a secure application module (SAM) and all messages sent to the management means are secured using the SAM.

44. A system as claimed in claim 38, wherein the management means includes a tamper resistant security module and all messages sent to the readers are secured using the tamper resistant security module.

45. A system as claimed in claim 38, wherein the management means are operable to send configuration information to the readers, which configuration information is for use in controlling one or more of the following reader functions: type of taggant to scan; the order in which features are to be scanned; the type of processing to use to determine the authentication information; where more than two taggants are on the article, which combination of taggants is to be used.

46. A system as claimed in claim 45 wherein the management means is operable to reconfigure the reader as and when desired.

47. A taggant reader for use in the system of claim 38 arranged to read taggant specific information from a machine readable taggant; process the taggant specific information to provide authentication information in a generic or common form and transmit the generic or common form information to the management means.

48. A taggant reader as claimed in claim 47 that is operable to provide generic information that is indicative of whether a read taggant is authentic.

49. A taggant reader as claimed in claim 47 that is operable to provide generic information that allows the management means to determine whether a read taggant is authentic.

50. A taggant reader as claimed in claim 47 including a secure application module (SAM).

51. A taggant reader as claimed in claim 50 wherein communications with the management means are secured using the SAM.

52. A taggant reader for reading taggant specific information from one or more different machine readable taggants, the reader being operable to process the read information to provide authentication information, wherein the reader is reconfigurable to read one or more different taggants and/or to use one or more different processes for processing the read information.

53. An authentication system for authenticating articles that bear one or more machine readable taggants, the system comprising management means for managing the operational state or configuration of a plurality of machine readable taggant instruments, for example a taggant reader and/or taggant writer, wherein the management means is operable to send to one or more of the instruments configuration or control instructions for implementing an on-board process, for example a taggant authentication process.

54. An authentication system as claimed in claim 53 wherein the management means is configured to download different configuration data to different ones of said plurality of taggant instruments.

55. An authentication system as claimed in claim 53 wherein configuration data depends on requirements detected by the system in the field, during use of the system.

56. An authentication system as claimed in claim 53 wherein the article to be authenticated bears two or more taggants and the configuration or control instructions are operable to cause the reader to read a particular one of the taggants.

57. A system for authenticating articles using information received from a plurality of taggant reader instruments, the taggant reader instruments being operable to read machine readable taggants associated with the articles, the taggants including the authentication or related information, the system comprising: an authentication manager for managing authentication information associated with the articles, and an instrument configuration manager for secure on-line configuration of the instruments, wherein the authentication manager is operable to use the authentication information received from the taggant reader instruments to identify suspicious events and the instrument configuration manager is operable to reconfigure on-line at least some of the taggant reader instruments when such suspicious events are identified.
